(19) United States
(12) Patent Application Publication
(10) Pub. No.: US 2021/0381544 A1
(43) Pub. Date: Dec. 9, 2021

(54) SHAFT DEVICE CAPABLE OF SENSING TORQUE

(71) Applicant: Yueh-Han Li, Guanshan Township (TW)

(72) Inventor: Yueh-Han Li, Guanshan Township (TW)

(21) Appl. No.: 17/339,015

(22) Filed: Jun. 4, 2021

(30) Foreign Application Priority Data
Jun. 8, 2020 (TW) 109119187

(51) Int. Cl. F16C 3/035; B62M 6/50

(52) U.S. Cl. CPC F16C 3/035; F16C 2326/28; F16C 2233/00; B62M 6/50

(57) ABSTRACT

A shaft device includes a shaft having a guide portion, a restraining member fixed to the shaft, and a movable member movably inserted into but non-rotatable relative to the restraining member and having a guide portion. When the shaft is rotated, the guide portions of the movable member and the shaft interact with each other to drive the movable member to axially displace. A restoring module is provided to restore the movable member to its original position after being axially displaced. A sensing module is provided for converting one of an axial displacement of the movable member and a deformation of the restoring module into a variable signal.

### CROSS-REFERENCE TO RELATED APPLICATION

This application claims priority to Taiwanese Patent Application No. 109119187, filed on Jun. 8, 2020.

### FIELD

The disclosure relates to a drive shaft, more particularly to a shaft device capable of sensing torque.

### BACKGROUND

A drive system of most of the power-assisted electric vehicles incudes an electric motor that provides auxiliary power. Power of the motor and pedaling force of a user are integrated to drive forward the power-assisted electric vehicle. As such, the purpose of saving the physical strength of the user can be achieved, and an output power of the motor can be adjusted according to the condition of the road. To achieve this goal, a pedaling force sensing mechanism can be provided on a pedaling force transmission path to sense whether the force exerted by the user on the pedal has increased or not, and then, according to the sensing result, the output power of the motor can be controlled to reduce the exerting force of the user.

A rotating shaft sensing device of an electric-assisted bicycle, as disclosed in Taiwanese Patent No. TWM503565, is used for sensing a pedaling torque of a user while riding and output a strain signal, thereby controlling an output power of a motor of a power-assist system to achieve an assisting effect. The rotating shaft sensing device includes a shaft, a strain gauge, and a control module. The shaft can rotate around its own axis. The strain gauge is fixed to an outer peripheral surface of the shaft, and is used for measuring the amount of strain generated by a pedaling torque of the user on the shaft and then generate a strain signal. The control module is used for receiving the strain signal and is electrically connected to the power-assist system. When the strain gauge senses that the torque received by the shaft is large, the control module will send a command to the power-assist system to output power so as to achieve an assisting effect, thereby improving the riding comfort.

### SUMMARY

Therefore, an object of the present disclosure is to provide an improved shaft device that is capable of sensing torque and that has a simple structure.

Accordingly, a shaft device of this disclosure includes a shaft, a restraining member fixed to the shaft, a movable member, a restoring module, and a sensing module. The shaft extends along an axis, is rotatable about the axis, and includes a shaft guide portion. The movable member is movably inserted into the restraining member along the axis, but is non-rotatable relative to the restraining member. The movable member includes a movable member guide portion corresponding to the shaft guide portion. One of the movable member guide portion and the shaft guide portion is inclined with respect to the axis. When the shaft is rotated, the movable member guide portion and the shaft guide portion interact with each other to drive the movable member to overcome a maximum static friction force relative to the restraining member and axially displace relative to the restraining member along the shaft.

The restoring module is disposed on one side of the movable member for providing a restoring force to restore the movable member to its original position after being axially displaced along the shaft. The sensing module is disposed on one of the restraining member, the movable member and the restoring module for converting one of an axial displacement of the movable member and a deformation of the restoring module into a variable signal.

### BRIEF DESCRIPTION OF THE DRAWINGS

Other features and advantages of the disclosure will become apparent in the following detailed description of the embodiments with reference to the accompanying drawings, of which:

FIG. 1 is an assembled sectional view of a shaft device according to the first embodiment of the present disclosure;

FIG. 2 is a view similar to FIG. 1, but illustrating a movable member being axially displaced relative to a restraining member;

FIG. 3 illustrates how a shaft guide portion moves from a position shown in FIG. 1 to a position shown in FIG. 2;

FIG. 4 is an assembled sectional view of a shaft device according to the second embodiment of the present disclosure;

FIG. 5 is an assembled sectional view of a shaft device according to the third embodiment of the present disclosure;

FIG. 6 is an assembled sectional view of a shaft device according to the fourth embodiment of the present disclosure;

FIG. 7 is an assembled sectional view of a shaft device according to the fifth embodiment of the present disclosure; and

FIG. 8 is an assembled sectional view of a shaft device according to the sixth embodiment of the present disclosure.

### DETAILED DESCRIPTION

Before the present disclosure is described in greater detail, it should be noted herein that like elements are denoted by the same reference numerals throughout the disclosure.

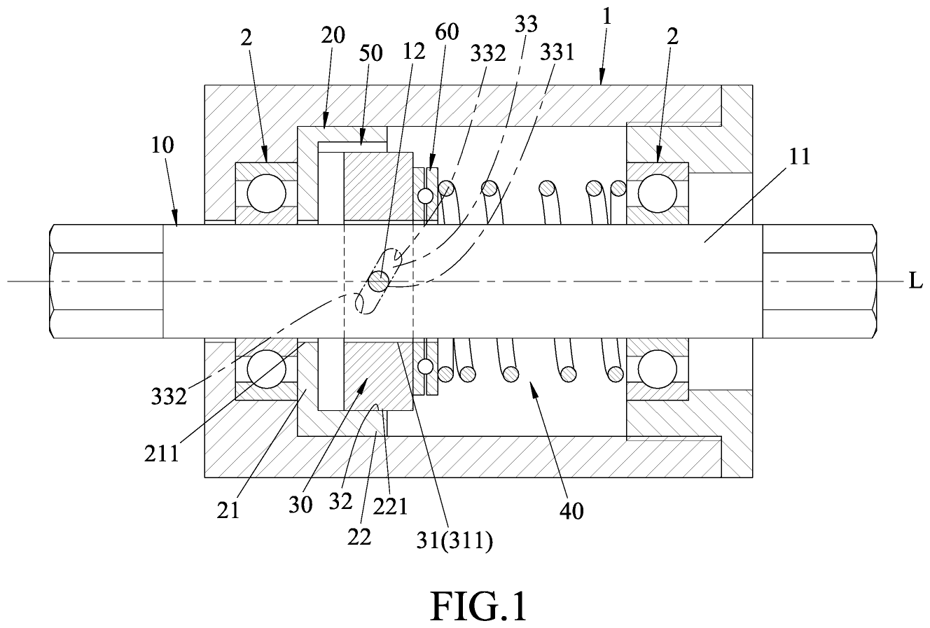

Referring to FIGS. 1 to 3, a shaft device according to the first embodiment of the present disclosure is configured to be mounted in an axial tube 1, and comprises a shaft 10, a restraining member 20, a movable member 30, a restoring module 40, a sensing module 50, and a plain bearing 60 disposed between the movable member 30 and the restoring module 40.

The shaft 10 extends along an axis (L), and is rotatably positioned to the axial tube 1 through a plurality of bearings 2. The shaft 10 has an outer peripheral surface 11 surrounding the axis (L), and a shaft guide portion 12 provided on the outer peripheral surface 11. In this embodiment, the shaft guide portion 12 is configured as a pin that protrudes radially from the outer peripheral surface 11.

The restraining member 20 is axially immovably and non-rotatably mounted on the outer peripheral surface 11 of the shaft 10, and is fixed to an inner portion of the axial tube 1. In this embodiment, the restraining member 20 has a substantially C-shaped cross section in a plane parallel to the axis (L), and includes an end wall 21 having a through hole 211 for extension of the shaft 10 therethrough, and a restraining wall 22 extending outwardly and transversely from a periphery of the end wall 21 and having a restraining surface 221 that faces the outer peripheral surface 11.

The movable member 30 has a ring shape, and is movably inserted into the restraining member 20 along the axis (L), but is non-rotatable relative to the restraining member 20. The movable member 30 has an inner peripheral surface 31 defining an inner hole 311, an outer peripheral surface 32 opposite to the inner peripheral surface 31, and a movable member guide portion 33 corresponding to the shaft guide portion 12. In this embodiment, the movable member guide portion 33 is configured as a groove extending from the inner peripheral surface 31 to the outer peripheral surface 32. The movable member guide portion 33 is inclined with respect to the axis (L), and has two opposite ends 332 and a middle part 331 between the two opposite ends 332. The movable member guide portion 33 and the shaft guide portion 12 interengage with each other.

The restoring module 40 is disposed on one side of the movable member 30 for providing a restoring force to restore the movable member 30 to its original position after being axially displaced relative to the restraining member 20 along the shaft 10. In this embodiment, the restoring module 40 is configured as a compression spring sleeved on the shaft 10 and having two opposite ends respectively abutting against the plain bearing 60 and one of the bearings 2.

In this embodiment, the sensing module 50 is configured as a proximity sensor disposed between the restraining member 20 and the movable member 30 for converting an axial displacement of the movable member 30 into a variable signal.

With reference to FIG. 1, the movable member 30 is in its original position, and the shaft guide portion 12 is located in the middle part 331 of the movable member guide portion 33. Further, the movable member 30 is in frictional contact with the restraining member 20, and is in a still position.

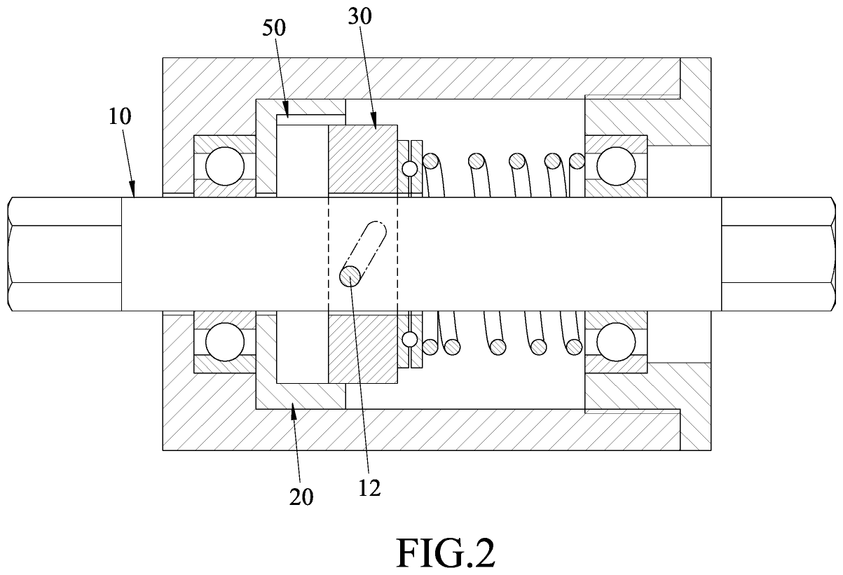

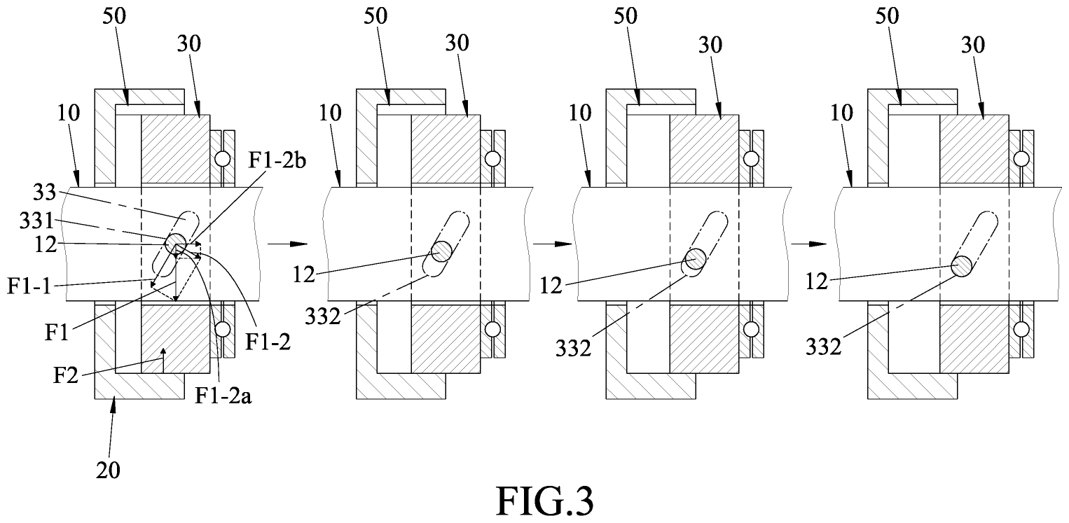

With reference to FIG. 2, when the shaft 10 is activated and rotates, it will drive the shaft guide portion 12 to rotate therewith. Through the inter-engagement of the shaft guide portion 12 and the movable member guide portion 33, and with the movable member guide portion 33 being an inclined groove, the rotating action of the shaft guide portion 12 will pull the movable member 30 to overcome a maximum static friction force relative to the restraining member 20 and axially displace relative to the restraining member 20 along the shaft 10. As shown in FIG. 3, the shaft guide portion 12 gradually moves from the middle part 331 to one of the two opposite ends 332 of the movable member guide portion 33, and as the displacement of the movable member 30 gradually increases, it will be sensed by the sensing module 50. The sensing module 50, in turn, will convert the displacement of the movable member 30 into a variable signal which can be processed to calculate a torque of the shaft 10. That is, when the shaft guide portion 12 is at different positions relative to the movable member guide portion 33, the different torques of the shaft 10 can be calculated through the variable signals sensed and converted by the sensing module 50. For example, when the shaft guide portion 12 is located in the middle part 331 of the movable member guide portion 33, the torque is calculated to be 0 Nm; and when the shaft guide portion 12 moves from the middle part 331 to one of the two opposite ends 332 of the movable member guide portion 33, the torque is calculated to be 20 Nm, 40 Nm, and 100 Nm.

With reference to FIG. 3, when the shaft guide portion 12 pulls the movable member 30, a first component force (F1-1) parallel to a length direction of the movable member guide portion 33 and a second component force (F1-2) perpendicular to the first component force (F1-1) cooperatively form a first combined force (F1), and the second component force (F1-2) is further divided into a component force (F1-2a) and a component force (F1-2b) perpendicular to each other. The component force (F1-2a) counteracts a restraining force (F2) provided by the restraining member 20 on the movable member 30. When the component force (F1-2b) is greater than the maximum static friction force relative to the restraining member 20, the movable member 30 can axially displace relative to the restraining member 20 along the shaft 10.

When the shaft device of this disclosure is applied to a drive shaft of an electric assisted bicycle, and when a torque applied by a rider to the shaft 10 reaches a predetermined value is sensed, a signal can be sent out to notify a motor that is electrically connected to the shaft device so as to adjust an auxiliary power thereof, thereby reducing an exerting force of the rider.

Therefore, in the shaft device of this disclosure, the rotation of the shaft 10 is used to drive the movable member 30 to axially displace relative to the restraining member 20, and the sensing module 50 is used to convert the axial displacement of the movable member into a variable signal which is subsequently processed to calculate the torque of the shaft 10, so that the purpose of sensing the torque of the shaft 10 can be achieved.

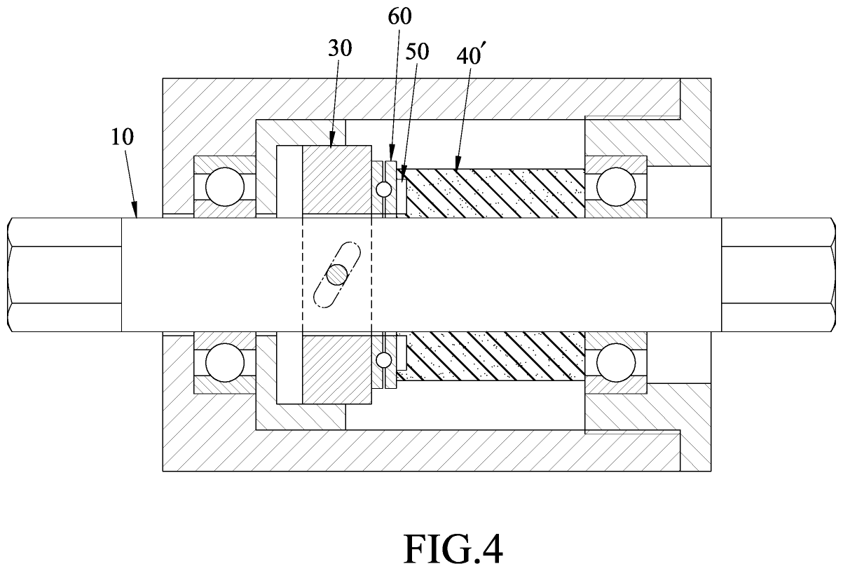

Referring to FIG. 4, a shaft device according to the second embodiment of the present disclosure is substantially identical to the first embodiment, but differs in that, in the second embodiment, the restoring module 40′ is made of an elastic material, such as rubber, and is configured as a tubular sleeve sleeved on the shaft 10. The sensing module 50 is disposed on one end of the restoring module 40′ that is adjacent to the plain bearing 60. Further, the sensing module 50 is a force sensor that generates a variable voltage signal proportional to a compressive force exerted by the movable member 30 against the restoring member 40′ after the movable member 30 is axially displaced relative to the restraining member 20 along the shaft 10. The second embodiment can similarly achieve the purpose and advantages of the first embodiment.

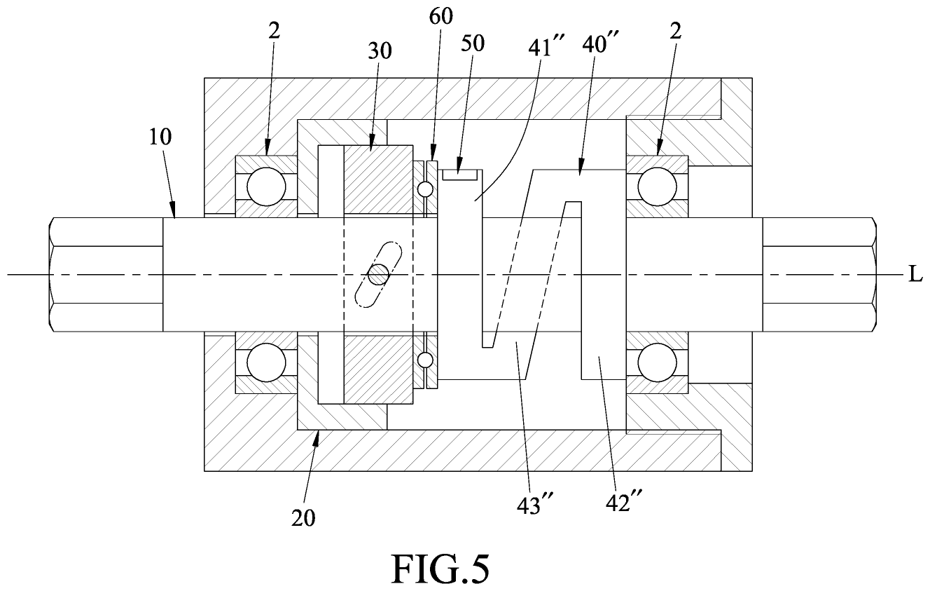

Referring to FIG. 5, a shaft device according to the third embodiment of the present disclosure is substantially identical to the first embodiment, but differs in that, in the third embodiment, the restoring module 40″ has a first end plate 41″ that is sleeved on the shaft 10, that is proximate to the movable member 30 and that abuts against the plain bearing 60, a second end plate 42″ opposite to the first end plate 41″ along the axis (L) and abutting against a corresponding one of the bearings 2, and a connecting plate 43″ connected between the first and second end plates 41″, 42″. The sensing module 50 is disposed on the first end plate 41″. The movable member 30 can compress and deform the restoring module 40″ as it is axially displaced relative to the restraining member 20 along the shaft 10. The sensing module 50 is configured to sense a deformation of the restoring module 40″, and then convert it into a variable signal.

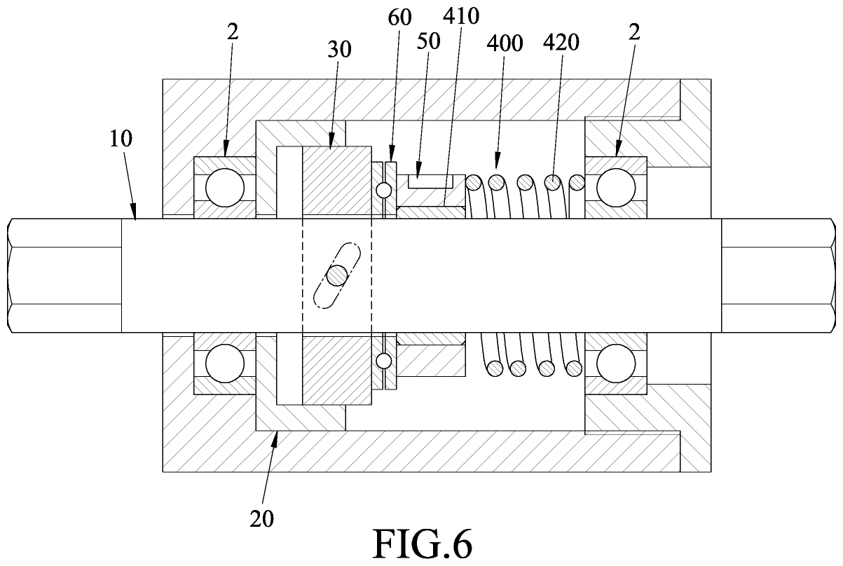

Referring to FIG. 6, a shaft device according to the fourth embodiment of the present disclosure is substantially identical to the first embodiment, but differs in that, in the fourth embodiment, the restoring module 400 includes a self-lubricating bearing 410 that is sleeved on the shaft 10, that is proximate to the movable member 30 and that abuts against the plain bearing 60, and a compression spring 420 sleeved on the shaft 10 and having two opposite ends respectively abutting against the self-lubricating bearing 410 and a corresponding one of the bearings 2. The sensing module 50 is disposed on the self-lubricating bearing 410. The movable member 30 can compress the restoring module 400 and deform the compression spring 420 as it is axially displaced relative to the restraining member along the shaft 10. The sensing module 50 is configured to sense a deformation of the compression spring 420, and then convert it into a variable signal.

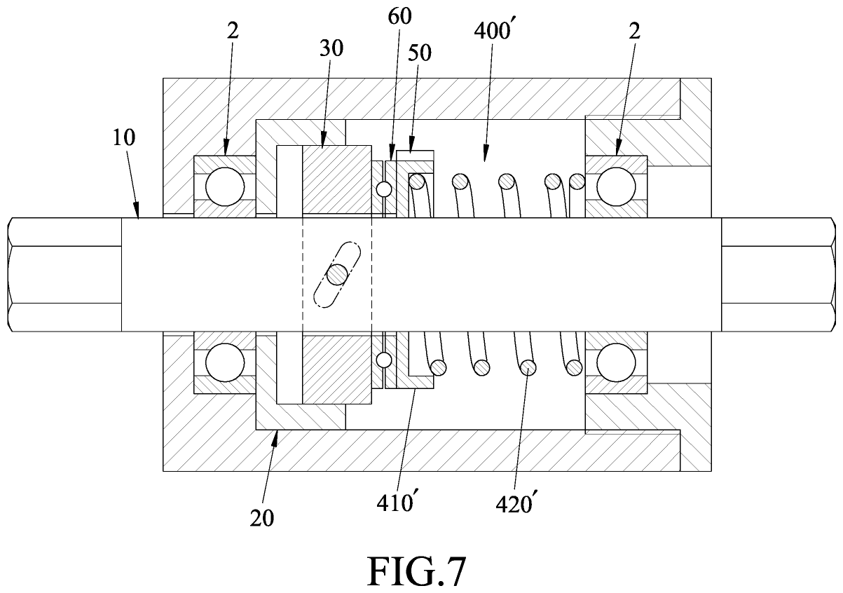

Referring to FIG. 7, a shaft device according to the fifth embodiment of the present disclosure is substantially identical to the first embodiment, but differs in that, in the fifth embodiment, the restoring module 400′ includes a sliding sleeve member 410′ sleeved on the shaft 10 and abutting against the plain bearing 60, and a compression spring 420′ sleeved on the shaft 10 and having two opposite ends respectively abutting against the sliding sleeve member 410′ and a corresponding one of the bearings 2. The sensing module 50 is disposed on the sliding sleeve member 410′. The movable member 30 can compress the restoring module 400′ and deform the compression ring 420′ as it is axially displaced relative to the restraining member 20 along the shaft 10. The sensing module 50 is configured to sense a deformation of the compression spring 420′, and then convert it into a variable signal.

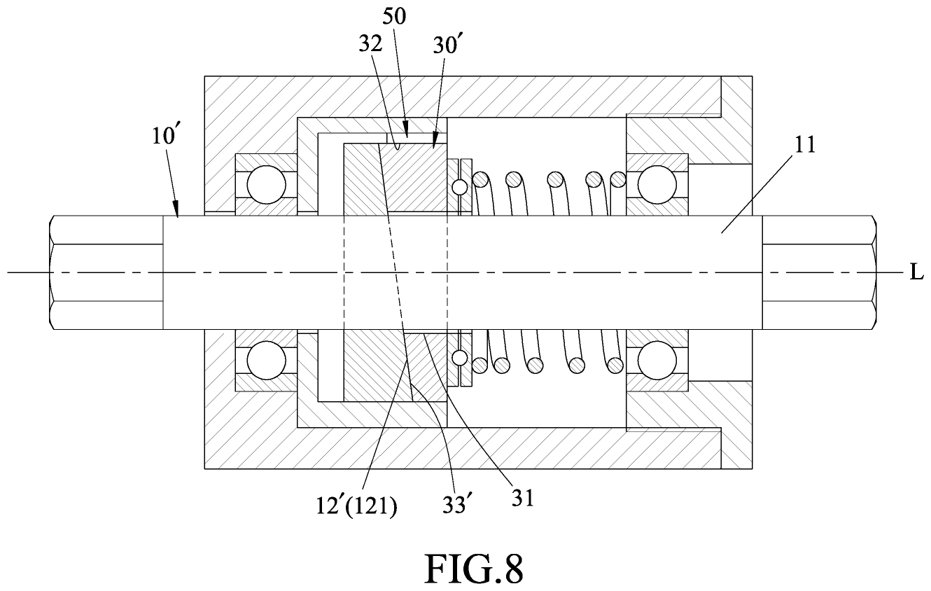

Referring to FIG. 8, a shaft device according to the sixth embodiment of the present disclosure is substantially identical to the first embodiment, but differs in that, in the sixth embodiment, the shaft guide portion 12′ is configured as an annular flange protruding outwardly and radially from the outer peripheral surface 11 of the shaft 10′, and has an inclined surface 121 inclined with respect to the axis (L). Further, the movable member guide portion 33′ is an end surface of the movable member 30′ interconnecting one ends of the inner and outer peripheral surfaces 31, 32 thereof, and is inclined with respect to the axis (L). The shaft guide portion 12′ and the movable member guide portion 33′ abut against each other.

When the shaft 10′ is rotated, the shaft guide portion 12′ pushes the movable member guide portion 33′ so that the movable member 30′ is axially displaced. When the sensing module 50 senses the displacement of the movable member 30′, it will convert the axial displacement of the movable member 30′ into a variable signal.

In summary, the shaft device of this disclosure has an overall structure that is simple, the manufacturing and assembly thereof are easy, and the torque of the shaft 10, 10′ can be sensed. Therefore, the object of this disclosure can indeed be achieved.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A shaft device comprising:
a shaft extending along an axis and rotatable about the axis, said shaft including a shaft guide portion;
a restraining member fixed to said shaft;
a movable member movably inserted into said restraining member along the axis, but non-rotatable relative to said restraining member, said movable member including a movable member guide portion corresponding to said shaft guide portion, one of said movable member guide portion and said shaft guide portion being inclined with respect to the axis, wherein, when said shaft is rotated, said movable member guide portion and said shaft guide portion interact with each other to drive said movable member to overcome a maximum static friction force relative to said restraining member and to axially displace relative to said restraining member along said shaft;
a restoring module disposed on one side of said movable member for providing a restoring force to restore said movable member to its original position after being axially displaced along said shaft; and
a sensing module disposed on one of said restraining member, said movable member and said restoring module for converting one of an axial displacement of said movable member and a deformation of said restoring module into a variable signal.

2. The shaft device as claimed in claim 1, wherein said shaft has an outer peripheral surface surrounding the axis, said shaft guide portion being provided on said outer peripheral surface, said movable member having an inner peripheral surface defining an inner hole for extension of said shaft therethrough, and an outer peripheral surface opposite to said inner peripheral surface, one of said movable member guide portion and said shaft guide portion being configured as a pin, the other one of said movable member guide portion and said shaft guide portion being configured as a groove inclined to the axis, said movable member guide portion and said shaft guide portion interengaging with each other, and wherein, when said shaft is rotated, said shaft drives said movable member guide portion and said shaft guide portion to produce relative displacement, and said sensing module converts the axial displacement of said movable member into a variable signal.

3. The shaft device as claimed in claim 2, wherein said said shaft guide portion is configured as a pin protruding radially from said outer peripheral surface of said shaft, and said movable member guide portion is configured as a groove extending from said inner peripheral surface to said outer peripheral surface of said movable member.

4. The shaft device as claimed in claim 2, wherein said sensing module is a proximity sensor.

5. The shaft device as claimed in claim 4, wherein said sensing module is disposed between said restraining member and said movable member.

6. The shaft device as claimed in claim 5, wherein said restoring module is a compression spring.

7. The shaft device as claimed in claim 1, wherein said restoring module includes a self-lubricating bearing sleeved on said shaft, and a compression spring sleeved on said shaft and abutting against said self-lubricating bearing, said sensing module being disposed on said self-lubricating bearing for converting the deformation of said restoring module into a variable signal.

8. The shaft device as claimed in claim 1, wherein said restoring module is made of an elastic material, and is configured as a tubular sleeve sleeved on said shaft, said sensing module being disposed on said restoring module.

9. The shaft device as claimed in claim 8, wherein said sensing module is a force sensor that can generate a variable voltage signal proportional to a compressive force exerted by said movable member against said restoring member after said movable member is axially displaced.

10. The shaft device as claimed in claim 1, wherein said restoring module includes a sliding sleeve member sleeved on said shaft 10, and a compression spring sleeved on said shaft and abutting against said sliding sleeve member, said sensing module being disposed on said sliding sleeve member.

11. The shaft device as claimed in claim 1, wherein said restoring module has a first end plate sleeved on said shaft and proximate to said movable member, a second end plate opposite to said first end plate along the axis, and a connecting plate connected between said first endplate and said second end plate, said sensing module being disposed on said first end plate.

12. The shaft device as claimed in claim 5, wherein said shaft has an outer peripheral surface surrounding the axis, said movable member having an inner peripheral surface defining an inner hole for extension of said shaft therethrough, and an outer peripheral surface opposite to said inner peripheral surface, said shaft guide portion being configured as an annular flange protruding outwardly and radially from said outer peripheral surface of said shaft, and having an inclined surface inclined with respect to the axis, said movable member guide portion being an end surface of said movable member that interconnects one ends of said inner peripheral surface and said outer peripheral surface of said movable member and that is inclined with respect to the axis, said inclined surface of said shaft guide portion and said movable member guide portion abutting against each other, and wherein, when said shaft is rotated, said shaft guide portion is driven to push said movable member guide portion so as to axially displace said movable member, said sensing module sensing and converting the displacement of said movable member into a variable signal.
